(19) United States
(12) Patent Application Publication
(10) Pub. No.: US 2005/0286191 A1
(43) Pub. Date: Dec. 29, 2005

(54) Power supply integrated circuit with multiple independent outputs

(76) Inventors: Pieter Vorenkamp, Laguna Niguel, CA (US); Neil Y. Kim, Laguna Niguel, CA (US); Sumant Ranganathan, Sunnyvale, CA (US); Chun-ying Chen, Irvine, CA (US)

Correspondence Address: MCANDREWS HELD & MALLOY, LTD, 500 WEST MADISON STREET, SUITE 3400, CHICAGO, IL, 60661, US

(21) Appl. No.: 11/166,832

(22) Filed: Jun. 24, 2005

Related U.S. Application Data
(60) Provisional application No. 60/583,322, filed on Jun. 28, 2004.

(51) Int. Cl. H02H 3/20

(52) U.S. Cl. 361/90

(57) ABSTRACT

A system and method for providing, in an integrated power supply circuit, signals corresponding to multiple power supply outputs. Various aspects of the present invention may comprise an integrated circuit. The integrated circuit may comprise a first module that outputs a first signal corresponding to electrical power that is characterized by a first set of power characteristics. The first set of power characteristics may, for example, comprise a first voltage level. The integrated circuit may also comprise a second module that outputs a second signal corresponding to electrical power that is characterized by a second set of power characteristics. The second set of power characteristics may, for example, comprise a second voltage level. The second voltage level may, for example, be substantially similar to the first voltage level, and the first set of power characteristics may, for example, be substantially different than the second set of power characteristics.

### CROSS-REFERENCE TO RELATED APPLICATIONS/INCORPORATION BY REFERENCE

This patent application is related to and claims priority from U.S. provisional patent application Ser. No. 60/583,322, filed Jun. 28, 2004, and entitled “POWER SUPPLY INTEGRATED CIRCUIT WITH MULTIPLE INDEPENDENT OUTPUTS,” the contents of which are hereby incorporated herein by reference in their entirety.

### FEDERALLY SPONSORED RESEARCH OR DEVELOPMENT

[Not Applicable]

### SEQUENCE LISTING

[Not Applicable]

MICROFICHE/COPYRIGHT REFERENCE

[Not Applicable]

### BACKGROUND OF THE INVENTION

Various circuits, modules or sub-systems in a system may have varying power supply requirements and/or may operate optimally when supplied with power having particular characteristics. Various circuits, modules or sub-systems in a system may also, for example, be relatively tolerant of power supply characteristics while other various circuits, modules or sub-systems may be relatively sensitive to power supply characteristics.

Power supply characteristics may vary in a variety of ways. For example, power supply characteristics may vary in voltage (or current) level, variance, noise level, ripple characteristics, load response characteristics, etc. Various power supply characteristics may be associated with respective power supply quality levels. For example, a power supply with a tightly regulated voltage with low ripple, low noise and a fast load response may be considered a relatively high quality power supply. Conversely for example, a power supply with a loosely regulated voltage with large ripple, a substantial noise component and slow load response may be considered a relatively low quality power supply.

Providing power to devices at a relatively high quality may require the consumption of more energy (e.g., by power supply circuitry) than providing power to devices at a relatively low quality level. In various system designs, power supply sub-systems may be designed to provide power to a set of chips or modules in accordance with the needs of a subset of chips or modules that have the strictest power supply requirements. Such designs may unnecessarily waste energy resources.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Various aspects of the present invention may provide a system and method for providing, in an integrated power supply circuit, signals corresponding to multiple power supply outputs, substantially as shown in and/or described in connection with at least one of the figures, as set forth more completely in the claims. These and other advantages, aspects and novel features of the present invention, as well as details of illustrative aspects thereof, will be more fully understood from the following description and drawings.

### BRIEF DESCRIPTION OF SEVERAL VIEWS OF THE DRAWINGS

FIG. 1 shows a block diagram of an exemplary integrated circuit comprising multiple modules generating power-related signals, in accordance with various aspects of the present invention.

FIG. 2 shows a block diagram of an exemplary integrated circuit comprising multiple modules generating power-related signals, in accordance with various aspects of the present invention.

FIG. 3 shows a block diagram of an exemplary integrated circuit comprising multiple modules generating power-related signals and additional modules, in accordance with various aspects of the present invention.

FIG. 4 shows a block diagram of an exemplary circuit utilizing an integrated circuit comprising multiple modules generating power-related signals, in accordance with various aspects of the present invention.

FIG. 5 shows a block diagram of an exemplary circuit utilizing an integrated circuit comprising multiple modules generating power-related signals, in accordance with various aspects of the present invention.

FIG. 6 shows a flow diagram of a method in an integrated circuit for providing multiple signals corresponding to electrical power, in accordance with various aspects of the present invention.

FIG. 7 shows a flow diagram of a method in an integrated circuit for providing multiple and controllable signals corresponding to electrical power, in accordance with various aspects of the present invention.

### DETAILED DESCRIPTION OF THE INVENTION

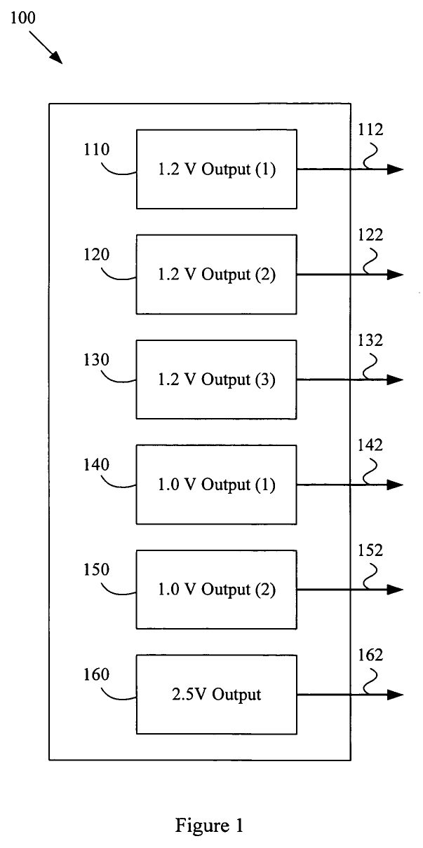

FIG. 1 shows a block diagram of an exemplary integrated circuit 100 comprising multiple modules generating power-related signals, in accordance with various aspects of the present invention. The exemplary integrated circuit 100 may, for example and without limitation, be a dedicated power supply integrated circuit (or power management unit) or an integrated circuit that comprises various power supply modules. The exemplary integrated circuit 100 may, for example, comprise a self-contained power supply integrated circuit that provides electrical power to other electrical circuits. Also for example, the exemplary integrated circuit 100 may comprise power supply control circuitry that generates control signals to control the operation of power supply circuitry (e.g., regulating, switching and/or filtering circuitry) that is external to the integrated circuit 100. Accordingly, the scope of various aspects of the present invention should not be limited by a particular type of integrated circuit.

The exemplary integrated circuit 100 may comprise a plurality of modules that each output one or more signals corresponding to electrical power. A “signal corresponding to electrical power” may, for example and without limitation, comprise a direct power output signal or a power control signal. That is, various aspects of the present invention may comprise a module that outputs a signal corresponding to electrical power, where the signal corresponding to electrical power comprises the electrical power. Alternatively, for example, various aspects of the present invention may comprise a module that outputs a signal corresponding to electrical power, where the signal corresponding to electrical power comprises one or more control signals that control the operation of additional power supply circuitry that, in turn, outputs the electrical power. Accordingly, the scope of various aspects of the present invention should not be limited by whether any of the plurality of exemplary modules to be discussed below output electrical power or output control signals related to electrical power.

As will be discussed below, the electrical power may be characterized by power characteristics. For example a first electrical power may be characterized by a first set of power characteristics. Such power characteristics may comprise any of a large variety of known power characteristics. For example and without limitation, such power characteristics may comprise voltage characteristics (e.g., voltage level, amount of voltage ripple, voltage tolerance range, voltage noise level, voltage load response characteristics, any measure of voltage variability, etc.). Also for example, such power characteristics may comprise electrical current characteristics (e.g., current level, amount of current fluctuation, current limit, any measure of current variance, current spike suppression, current load response characteristics, etc.). Further for example, such power characteristics may comprise any of various metrics associated with electrical power and/or energy. Accordingly, the scope of various aspects of the present invention should not be limited by one or more particular characteristics of electrical power.

Note that in various scenarios, a set of power characteristics may be associated with a power quality level. For example, higher quality power characteristics may have relatively low noise, relatively fast load response characteristics, relatively low ripple or other forms of variance, relatively high current capability, etc. Accordingly, a set of power characteristics may, at times, be associated with a particular power quality level. However, the scope of various aspects of the present invention should not be limited by any arbitrary association between notions of power quality and particular power characteristics.

The exemplary integrated circuit 100 may comprise a first module 110. The first module 110 may output a signal corresponding to electrical power 112 that is characterized by a first set of power characteristics. As mentioned previously, the first set of power characteristics may comprise any of a large variety of characteristics of electrical power. Also as mentioned previously, the signal corresponding to electrical power 112 may comprise the electrical power or may comprise one or more control signals related to the electrical power.

The first set of power characteristics may, for example, be relatively constant during operation of the exemplary integrated circuit 100. In an alternative scenario to be discussed later, the first set of power characteristics may be variable during operation of the integrated circuit 100. In a non-limiting exemplary scenario, the first module 110 may output a signal corresponding to electrical power 112 at a voltage level of approximately 1.2V at a tolerance level of ±1%, with relatively fast load response characteristics, a relatively low amount of noise and a maximum current of 2 A.

The exemplary integrated circuit 100 may comprise a second module 120. The second module 120 may output a signal corresponding to electrical power 122 that is characterized by a second set of power characteristics. As mentioned previously, the second set of power characteristics may comprise any of a large variety of characteristics of electrical power. Also as mentioned previously, the signal corresponding to electrical power 122 may comprise the electrical power or may comprise one or more control signals related to the electrical power.

The second module 120 may, for example, be independent of the first module 110. For example, the second module 120 may output signals in a manner that does not depend on the operation or state of the first module 110. The second module 120 and first module 110 may, of course, generally operate independently while sharing various hardware and/or software components.

For example, the second set of power characteristics may comprise a second voltage level, second tolerance range(s), second load response characteristics, noise characteristics, current limit, etc. Any of the second set of power characteristics may, for example, be substantially the same or substantially different than any of the corresponding first set of power characteristics. For example and without limitation, the second voltage level may be substantially the same as the first voltage level. That is, the first and second voltage levels may generally correspond to a set of devices that are specified to operate at a particular voltage level. In the non-limiting exemplary scenario, the first and second voltage levels may generally correspond to 1.2 Volt devices. In the exemplary scenario, the first voltage level may be approximately 1.2V and the second voltage level may be approximately 1.1V or 1.15V.

Also for example and without limitation, a first portion of the first set of power characteristics may be substantially the same as a corresponding first portion of the second set of power characteristics, and a second portion of the first set of power characteristics may be substantially different than a corresponding second portion of the second set of power characteristics. For example, the first voltage level and the second voltage level may be substantially similar, while any one or more of the remaining power characteristics (e.g., ripple level or any of the power characteristics discussed previously) may be substantially different.

In an exemplary scenario, the first ripple level may be 2%. For example, the second ripple level may be substantially similar to the first ripple level (e.g., 2.1%). Alternatively, for example, the second ripple level may be substantially different than the first ripple level (e.g., 3%). In another exemplary scenario, the first voltage tolerance range may be 5%. For example, the second voltage tolerance range may be substantially similar to the first voltage tolerance range (e.g., at 5.2%) or may be substantially different than the first voltage tolerance range (e.g., at 7%). In general, what is substantially different or substantially similar is context dependent and depends on each particular power characteristic.

The second set of power characteristics may, for example, be relatively constant during operation of the exemplary integrated circuit 100. In an alternative scenario to be discussed later, the second set of power characteristics may be variable during operation of the integrated circuit 100.

In a non-limiting exemplary scenario, the second module 120 may output a signal corresponding to electrical power 122 at a voltage level of approximately 1.2V at a tolerance level of ±5%, with relatively moderate load response characteristics, a relatively moderate amount of noise and a maximum current of 1 A.

The exemplary integrated circuit 100 may comprise a third module 130. The third module 130 may output a signal corresponding to electrical power 132 that is characterized by a third set of power characteristics. As mentioned previously, the third set of power characteristics may comprise any of a large variety of characteristics of electrical power. Also as mentioned previously, the signal corresponding to electrical power 132 may comprise the electrical power or may comprise one or more control signals related to the electrical power.

For example, the third set of power characteristics may comprise a third voltage level, third tolerance range(s), third load response characteristics, noise characteristics, current limit, etc. Any of the third set of power characteristics may, for example, be substantially the same or substantially different than any of the corresponding first and second sets of power characteristics associated with the first 110 and second 120 modules, respectively. For example and without limitation, the third voltage level may be substantially the same as the first and second voltage levels. That is, the first, second and third voltage levels may generally correspond to a set of devices that are specified to operate at a particular voltage level. In an exemplary scenario, the first, second and third voltage levels may generally correspond to 1.2 Volt devices. In the exemplary scenario, the first voltage level may be approximately 1.2V, the second voltage level may be approximately 1.15V, and the third voltage level may be approximately 1.22V.

Also for example and without limitation, a first portion of the third set of power characteristics may be substantially the same as corresponding first portions of the first and/or second sets of power characteristics, and a second portion of the third set of power characteristics may be substantially different than corresponding second portions of the first and/or second sets of power characteristics. In an exemplary scenario, the first, second and third voltage levels may be substantially similar, while any one or more of the remaining power characteristics (e.g., ripple level or any of the power characteristics discussed previously) may be substantially different.

In an exemplary scenario, the first ripple level may be 2%, and the second ripple level may be 3%. For example, the third ripple level may be substantially similar to the first ripple level (e.g., 2.1%). Alternatively, for example, the second ripple level may be substantially different than the first and second ripple levels (e.g., 5%). In another exemplary scenario, the first voltage tolerance range may be 5%, and the second voltage tolerance range may be 5%. For example, the third voltage tolerance range may be substantially similar to the first and second voltage tolerance ranges (e.g., at 5.2%) or may be substantially different than the first and second voltage tolerance ranges (e.g., at 10%).

The third set of power characteristics may, for example, be relatively constant during operation of the exemplary integrated circuit 100. In an alternative scenario to be discussed later, the third set of power characteristics may be variable during operation of the integrated circuit 100.

In a non-limiting exemplary scenario, the third module 130 may output a signal corresponding to electrical power 132 at a voltage level of approximately 1.2V at a tolerance level of ±10%, with relatively slow load response characteristics, a relatively high amount of noise and a maximum current of 500 mA.

The exemplary integrated circuit 100 may comprise a fourth module 140. The fourth module 140 may output a signal corresponding to electrical power 142 that is characterized by a fourth set of power characteristics. As mentioned previously, the fourth set of power characteristics may comprise any of a large variety of characteristics of electrical power. Also as mentioned previously, the signal corresponding to electrical power 142 may comprise the electrical power or may comprise one or more control signals related to the electrical power.

For example, the fourth set of power characteristics may comprise a fourth voltage level, fourth tolerance range(s), fourth load response characteristics, noise characteristics, current limit, etc. Any of the fourth set of power characteristics may, for example, be substantially the same or substantially different than any of the corresponding sets of power characteristics associated with the first 110, second 120 and third 130 modules, respectively. For example and without limitation, the fourth voltage level may be substantially different than the first, second and third voltage levels. That is, the first, second and third voltage levels may generally correspond to a set of devices that are specified to operate at a first particular voltage level, and the fourth voltage level may generally correspond to a set of devices that are specified to operate at a second particular voltage level. In an exemplary scenario, the first, second and third voltage levels may generally correspond to 1.2 Volt devices, and the fourth voltage level may generally correspond to 1.0 Volt devices. In the exemplary scenario, the first, second and third voltage levels may be approximately 1.2V, the fourth voltage level may be approximately 1.0V.

The fourth set of power characteristics may, for example, be relatively constant during operation of the exemplary integrated circuit 100. In an alternative scenario to be discussed later, the fourth set of power characteristics may be variable during operation of the integrated circuit 100.

In a non-limiting exemplary scenario, the fourth module 140 may output a signal corresponding to electrical power 142 at a voltage level of approximately 1.0V at a tolerance level of ±2%, with relatively fast load response characteristics, a relatively low amount of noise and a maximum current of 1.5 A.

The exemplary integrated circuit 100 may comprise a fifth module 150. The fifth module 150 may output a signal corresponding to electrical power 152 that is characterized by a fifth set of power characteristics. As mentioned previously, the fifth set of power characteristics may comprise any of a large variety of characteristics of electrical power. Also as mentioned previously, the signal corresponding to electrical power 152 may comprise the electrical power or may comprise one or more control signals related to the electrical power.

For example, the fifth set of power characteristics may comprise a fifth voltage level, fifth tolerance range(s), fifth load response characteristics, noise characteristics, current limit, etc. Any of the fifth set of power characteristics may, for example, be substantially the same or substantially different than any of the corresponding fourth set of power characteristics. For example and without limitation, the fifth voltage level may be substantially the same as the fourth voltage level. That is, the fourth and fifth voltage levels may generally correspond to a set of devices that are specified to operate at a particular voltage level. In an exemplary scenario, the fourth and fifth voltage levels may generally correspond to 1.0 Volt devices. In the exemplary scenario, the fourth voltage level may be approximately 1.0V and the fifth voltage level may be approximately 0.9V or 1.1V.

Also for example and without limitation, a first portion of the fifth set of power characteristics may be substantially the same as a corresponding first portion of the fourth set of power characteristics, and a second portion of the fifth set of power characteristics may be substantially different than a corresponding second portion of the fourth set of power characteristics. In an exemplary scenario, the fourth voltage level and the fifth voltage level may be substantially similar, while any one or more of the remaining fourth and fifth sets of power characteristics (e.g., ripple level or any of the power characteristics discussed previously) may be substantially different.

In an exemplary scenario, the fourth ripple level may be 4%. For example, the fifth ripple level may be substantially similar to the fourth ripple level (e.g., 4.3%). Alternatively, for example, the fifth ripple level may be substantially different than the fourth ripple level (e.g., 6%). In another exemplary scenario, the fourth voltage tolerance range may be 2%. For example, the fifth voltage tolerance range may be substantially similar to the fourth voltage tolerance range (e.g., at 2.2%) or may be substantially different than the fourth voltage tolerance range (e.g., at 5%). As mentioned previously, what is substantially different or substantially the same is context dependent and depends on each particular power characteristic.

The fifth set of power characteristics may, for example, be relatively constant during operation of the exemplary integrated circuit 100. In an alternative scenario to be discussed later, the fifth set of power characteristics may be variable during operation of the integrated circuit 100.

In a non-limiting exemplary scenario, the fifth module 150 may output a signal corresponding to electrical power 152 at a voltage level of approximately 1.0V at a tolerance level of ±8%, with relatively slow load response characteristics, a relatively high amount of noise and a maximum current of 400 mA.

The exemplary integrated circuit 100 may comprise a sixth module 160. The exemplary sixth module 160 may output a signal corresponding to electrical power 162 that is characterized by a sixth set of power characteristics. The sixth set of power characteristics may, for example, be relatively constant during operation of the exemplary integrated circuit 100. In a non-limiting exemplary scenario, the sixth module 160 may output a signal corresponding to electrical power 162 at a voltage level of 2.5V at a tolerance level of ±5% and with a maximum current of 500 mA.

The exemplary system 100 illustrated in FIG. 1 and discussed previously provides specific illustrative examples of a portion of various generally broader aspects of the present invention. Accordingly, the scope of various aspects of the present invention should not be limited by particular characteristics of the exemplary system 100.

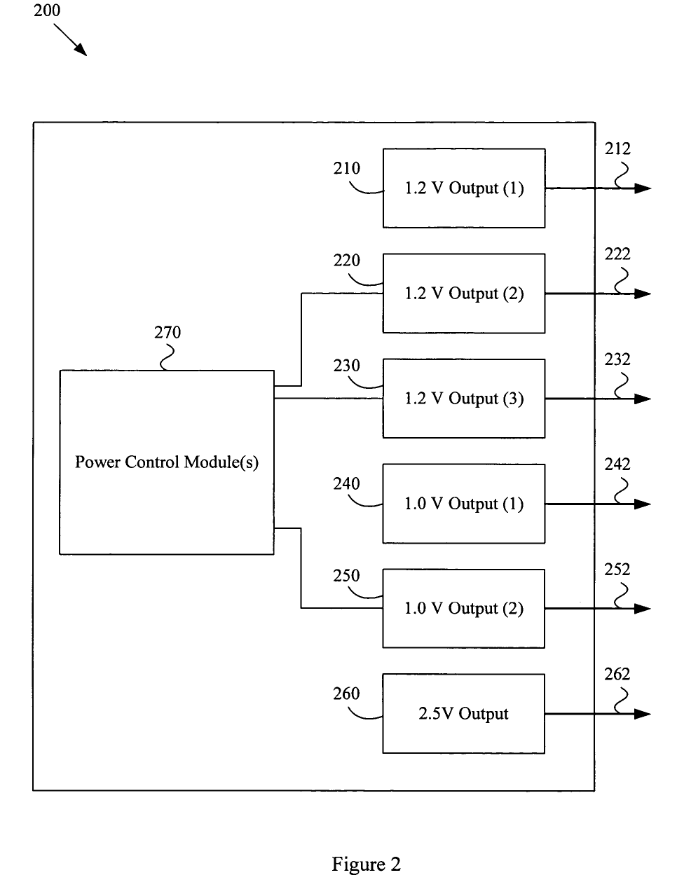

FIG. 2 shows a block diagram of an exemplary integrated circuit 200 comprising multiple modules generating power-related signals, in accordance with various aspects of the present invention. The exemplary integrated circuit 200 may, for example and without limitation share various aspects with the exemplary integrated circuit 100 illustrated in FIG. 1 and discussed previously.

The exemplary integrated circuit 200 may comprise a plurality of modules 210, 220, 230, 240, 250 and 260, each of which output respective signals 212, 222, 232, 242, 252 and 262 corresponding to electrical power that is characterized by respective sets of power characteristics. The exemplary modules 210-610 and respective output signals 212-262 may, for example, share various characteristics with the exemplary modules 110-160 and respective output signals 112-162 illustrated in FIG. 1 and discussed previously.

As mentioned previously with regard to the exemplary integrated circuit 100 illustrated in FIG. 1, the power characteristics of electrical power associated with the various module output signals may be constant or variable during operation of the integrated circuit 200. In the exemplary scenario illustrated in FIG. 2, the output signals 212, 242 and 262 associated with the modules 210, 240 and 260 may exhibit relatively constant behavior during operation of the integrated circuit 200. Also in the exemplary scenario, the output signals 222, 232 and 252 associated with the modules 220, 230 and 250 may exhibit variable behavior (e.g., controlled variable behavior) during operation of the integrated circuit 200.

The exemplary system 200 may comprise a power control module 270 that controls various operational aspects of various modules. The power control module 270 may, for example, communicate controlling signals to various modules to control various aspects of module operation. Such control may, for example, be predetermined or in response to real-time events or conditions. For example, such control may be in response to one or more signals received from a user or another system. Such control may, for example, occur during system initialization or during run-time.

For example, the power control module 270 may be communicatively coupled to the second module 220, third module 230 and fifth module 250. The power control module 270 may, for example, communicate control signals to the coupled modules 220, 230 and 250 to control the generation of signals 222, 232 and 252 by the modules 220, 230 and 250. In an exemplary scenario where output signals from the modules comprise electrical power, the power control module 270 may communicate with the various modules 220, 230 and 250 to control characteristics of the electrical power. In another exemplary scenario where output signals from the modules comprise control signals for controlling operation of other power providing circuitry, the power control module 270 may control aspects of the output control signals, thereby controlling characteristics of the electrical power associated with the control signals.

In the exemplary system 200 illustrated in FIG. 2, the power control module 270 may control operation of the second module 220. The power control module 270 may thereby control various characteristics of the electrical power associated with the signal 222 output from the second module 220. Similarly, the power control module 270 may control operation of the third module 230. The power control module 270 may thereby control various characteristics of the electrical power associated with the signal 232 output from the third module 230. Also, the power control module 270 may control operation of the fifth module 250. The power control module 270 may thereby control various characteristics of the electrical power associated with the signal 252 output from the fifth module 250.

The exemplary system 200 illustrated in FIG. 2 and discussed previously provides specific illustrative examples of a portion of various generally broader aspects of the present invention. Accordingly, the scope of various aspects of the present invention should not be limited by particular characteristics of the exemplary system 200.

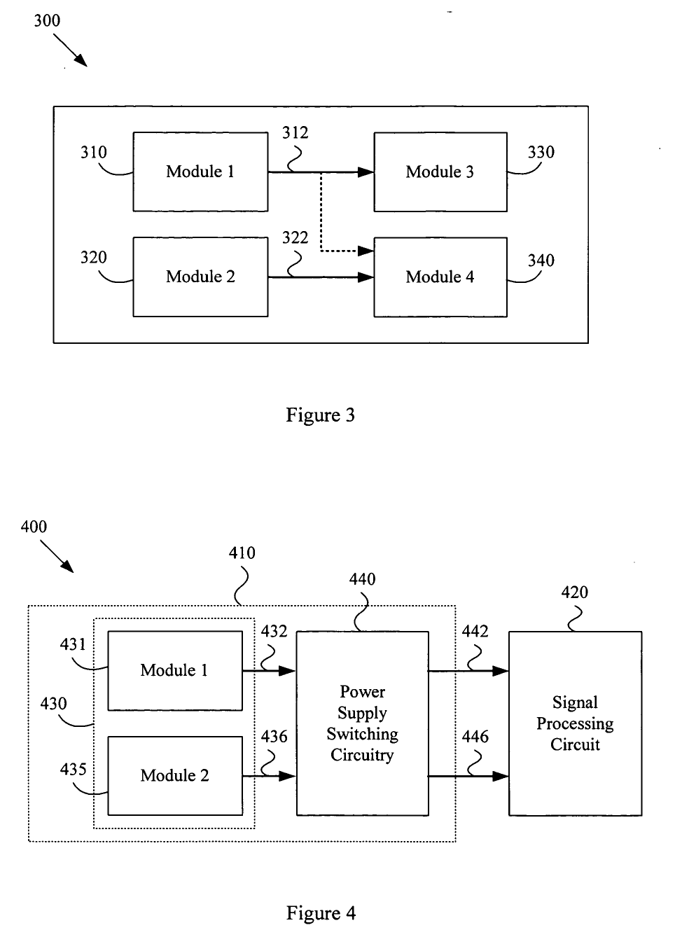

FIG. 3 shows a block diagram of an exemplary integrated circuit 300 comprising multiple modules generating power-related signals and additional modules, in accordance with various aspects of the present invention. The exemplary integrated circuit 300 may, for example and without limitation, share various characteristics with the exemplary integrated circuits 100, 200 illustrated in FIGS. 1-2 and discussed previously.

The exemplary system 300 may comprise a first module 310 and a second module 320. The first 310 and second 320 modules may, for example and without limitation, share various characteristics with the first 110 and second 120 modules of the exemplary system 100 illustrated in FIG. 1 and discussed previously, and with the first 210 and second 220 modules of the exemplary system 200 illustrated in FIG. 2 and discussed previously.

The first module 310 may output a first signal 312 corresponding to electrical power that is characterized by a first set of power characteristics. As mentioned previously, such a signal 312 may comprise the electrical power characterized by the first set of power characteristics. The second module 320 may output a second signal 322 corresponding to electrical power that is characterized by a second set of power characteristics. As mentioned previously, such a signal 322 may comprise the electrical power characterized by the second set of power characteristics.

The exemplary system 300 may comprise a third module 330. The third module 330 may, for example, be a module that performs power supply functionality. For example, the third module 330 may perform power supply switching, regulating, or filtering. Alternatively, the third module 330 might not perform power supply functionality. For example, the third module 330 might perform signal processing, data communication, data storage, etc. The third module 330 may, for example, receive the first signal 312 from the first module 310. In an exemplary scenario, the third module 330 may receive the first signal 312, which comprises the electrical power characterized by the first set of power characteristics, and utilize the electrical power to perform signal processing activities.

The exemplary system 300 may comprise a fourth module 340. The fourth module 340 may, for example, be a module that performs power supply functionality. For example, the fourth module 340 may perform power supply switching, regulating, or filtering. Alternatively, the fourth module 340 might not perform power supply functionality. For example, the fourth module 340 might perform signal processing, data communication, data storage, etc. The fourth module 340 may, for example, receive the second signal 322 from the second module 320. The fourth module 340 may also, for example, receive the first signal 312 from the first module 310.

In an exemplary scenario, the fourth module 340 may receive the first signal 312, which comprises the electrical power characterized by the first set of power characteristics, and utilize such electrical power to perform signal processing activities. In the exemplary scenario, the fourth module 340 may also receive the second signal 322, which comprises the electrical power characterized by the second set of power characteristics, and also utilize such electrical power to perform signal processing activities.

FIG. 4 shows a block diagram of an exemplary circuit 400 utilizing an integrated circuit comprising multiple modules generating power-related signals, in accordance with various aspects of the present invention. Various components of the exemplary circuit 400 (e.g., integrated circuit 430) may, for example and without limitation, share various characteristics with the exemplary integrated circuits 100, 200 and 300 illustrated in FIGS. 1-3 and discussed previously.

The exemplary circuit 400 may comprise any of a large variety of circuit types. For example and without limitation, the exemplary circuit 400 may comprise a signal processing circuit (e.g., video signal processing, audio signal processing, data signal processing, mixed analog/digital circuitry, micro-processing, digital signal processing, etc.). For example, the exemplary circuit 400 may comprise a television set top box, an audio receiver, a portable computer, portable communication device, video player, portable computer, audio player, data storage system, information networking apparatus, automobile electronics, home appliance electronics, telecommunications system, etc. Accordingly, though the following discussion will generally refer to a signal processing circuit, the scope of various aspects of the present invention should not be limited by characteristics of a particular type of circuit.

The exemplary circuit 400 may comprise a power supply circuit 410 and a signal processing circuit 420. The power supply circuit 410 may comprise a power supply integrated circuit 430 and power supply switching circuitry 440. The power supply integrated circuit 430 may, for example and without limitation, share various characteristics with the exemplary integrated circuits 100, 200 and 300 illustrated in FIGS. 1-3 and discussed previously.

The power supply integrated circuit 430 may comprise a first module 431 that outputs a first signal 432 corresponding to electrical power 442 that is characterized by a first set of power characteristics (e.g., including a first voltage level). The first module 431 may, for example and without limitation, share various characteristics with the first module 110 of the exemplary integrated circuit 100 illustrated in FIG. 1 and discussed previously or with the first module 210 of the exemplary integrated circuit 200 illustrated in FIG. 2 and discussed previously.

As mentioned previously with regard to the first module 110 of the exemplary integrated circuit 100 of FIG. 1, the first signal 432 may comprise a control signal that causes the power supply circuit 410 to output electrical power 442 that is characterized by the first set of power characteristics. In the exemplary circuit 400, the power supply switching circuitry 440 receives the first signal 432 from the power supply integrated circuit 430, and outputs the electrical power 442 that is characterized by the first set of power characteristics. The power supply circuit 410 may supply the electrical power 442 to the signal processing circuit 420, which may then utilize the electrical power 442 to perform signal processing.

The power supply integrated circuit 430 may comprise a second module 435 that outputs a second signal 436 corresponding to electrical power 446 that is characterized by a second set of power characteristics (e.g., including a second voltage level). The second module 435 may, for example and without limitation, share various characteristics with the second module 120 of the exemplary integrated circuit 100 illustrated in FIG. 1 and discussed previously or the second module 220 of the exemplary integrated circuit 200 illustrated in FIG. 2 and discussed previously. For example and without limitation, the second voltage level might be substantially similar to the first voltage level, and the first set of power characteristics might be substantially different than the second set of power characteristics.

As mentioned previously with regard to the second module 120 of the exemplary integrated circuit 100 of FIG. 1, the second signal 436 may comprise a control signal that causes the power supply circuit 410 to output electrical power 446 that is characterized by the second set of power characteristics (e.g., including a second voltage level). In the exemplary circuit 400, the power supply switching circuitry 440 receives the second signal 436 from the power supply integrated circuit 430, and outputs the electrical power 446 that is characterized by the second set of power characteristics. The power supply circuit 410 may supply the electrical power 446 to the signal processing circuit 420, which may then utilize the electrical power 446 to perform signal processing.

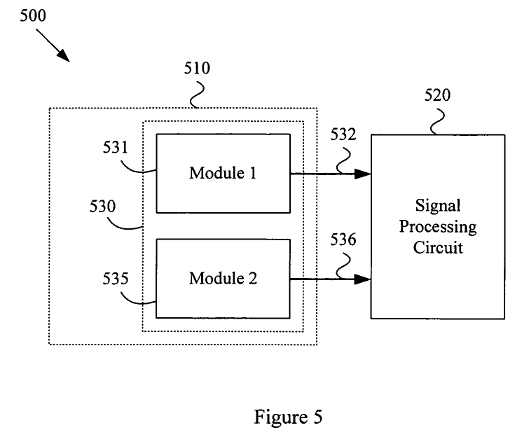

FIG. 5 shows a block diagram of another exemplary circuit 500 utilizing an integrated circuit comprising multiple modules generating power-related signals, in accordance with various aspects of the present invention. Various components of the exemplary circuit 500 (e.g., integrated circuit 530) may, for example and without limitation, share various characteristics with the exemplary circuits 100, 200, 300 and 400 illustrated in FIGS. 1-4 and discussed previously. For example, the exemplary circuit 500 may comprise any of a large variety of circuit types. Accordingly, though the following discussion will generally refer to a signal processing circuit, the scope of various aspects of the present invention should not be limited by characteristics of a particular type of circuit.

The exemplary circuit 500 may comprise a power supply circuit 510 and a signal processing circuit 520. The power supply circuit 510 may comprise a power supply integrated circuit 530. The power supply integrated circuit 530 may, for example and without limitation, share various characteristics with the exemplary integrated circuits 100, 200 and 300 illustrated in FIGS. 1-3 and discussed previously.

The power supply integrated circuit 530 may comprise a first module 531 that outputs a first signal 532 corresponding to electrical power that is characterized by a first set of power characteristics (e.g., including a first voltage level). The first module 531 may, for example and without limitation, share various characteristics with the first module 110 of the exemplary integrated circuit 100 illustrated in FIG. 1 and discussed previously or with the first module 210 of the exemplary integrated circuit 200 illustrated in FIG. 2 and discussed previously.

As mentioned previously with regard to the first module 110 of the exemplary integrated circuit 100 of FIG. 1, the first signal 532 may comprise the electrical power that is characterized by the first set of power characteristics. In the exemplary circuit 500, the power supply integrated circuit 530 outputs the electrical power (e.g., in the first signal 532) that is characterized by the first set of power characteristics. The power supply circuitry 510 may supply the electrical power 532 to the signal processing circuit 520, which may then utilize the electrical power 532 to perform signal processing.

The power supply integrated circuit 530 may comprise a second module 535 that outputs a second signal 536 corresponding to electrical power that is characterized by a second set of power characteristics (e.g., including a second voltage level). The second module 535 may, for example and without limitation, share various characteristics with the second module 120 of the exemplary integrated circuit 100 illustrated in FIG. 1 and discussed previously or with the second module 220 of the exemplary integrated circuit 200 illustrated in FIG. 2 and discussed previously. For example and without limitation, the second voltage level might be substantially similar to the first voltage level, and the first set of power characteristics might be substantially different than the second set of power characteristics.

As mentioned previously with regard to the second module 120 of the exemplary integrated circuit 100 of FIG. 1, the second signal 536 may comprise the electrical power that is characterized by the second set of power characteristics. In the exemplary circuit 500, the power supply integrated circuit 530 outputs the electrical power (e.g., in the second signal 536) that is characterized by the second set of power characteristics. The power supply circuitry 510 may supply the electrical power 536 to the signal processing circuit 520, which may then utilize the electrical power 536 to perform signal processing.

The exemplary circuits 400, 500 illustrated in FIGS. 4-5 and discussed previously provide specific illustrative examples of a portion of various generally broader aspects of the present invention. Accordingly, the scope of various aspects of the present invention should not be limited by particular characteristics of the exemplary circuits 400, 500.

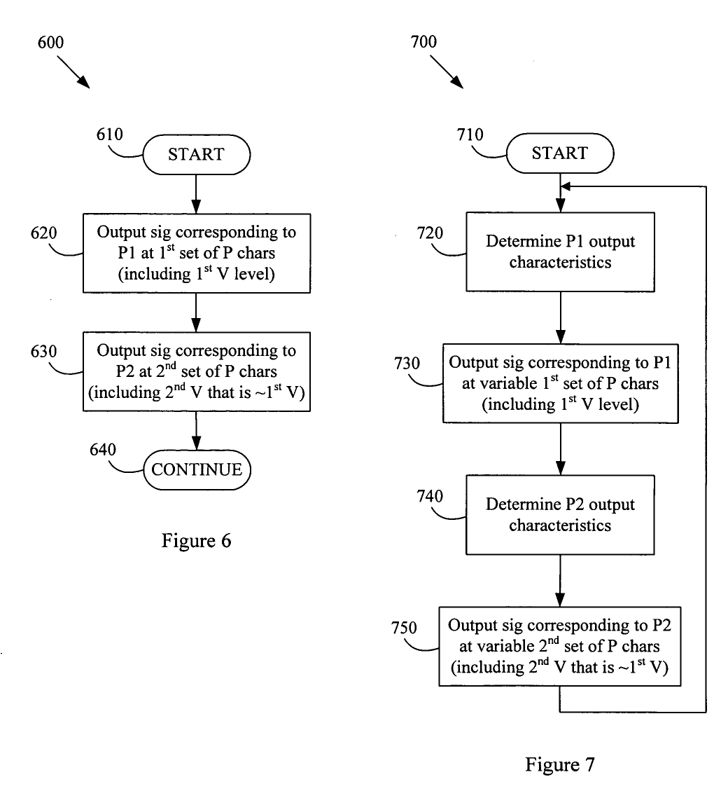

FIG. 6 shows a flow diagram of a method 600 in an integrated circuit for providing multiple signals corresponding to electrical power (e.g., multiple independent output signals), in accordance with various aspects of the present invention. The method 600 may, for example and without limitation, share various aspects with the functionality performed by the exemplary integrated circuits illustrated in FIGS. 1-5 and discussed previously.

The exemplary method 600 may begin at step 610. The method 600 may begin in response to any of a large number of initiating causes or events. For example and without limitation, the method 600 may begin in response to a power-up event, a system reset event, a detected operating condition, a user command, predetermined periodic behavior, etc. Accordingly, the scope of various aspects of the present invention should not be limited by characteristics of any particular initiating cause or event.

The exemplary method 600 may, at step 620, comprise generating a first signal corresponding to electrical power that is characterized by a first set of power characteristics. Step 620 may, for example and without limitation, perform a portion, all, or more than the functionality discussed previously with regard to the first modules 110, 210, 310, 431 and/or 531 of the exemplary systems illustrated in FIGS. 1-5 and discussed previously.

As discussed previously, such power characteristics may, for example and without limitation, comprise a first voltage level, first voltage tolerance level, first load response characteristic, first noise level, first current limit, and/or many other known power characteristics. Also, as discussed previously, the first signal corresponding to electrical power may comprise the electrical power or may comprise a control signal that causes power supply circuitry to generate the electrical power that is characterized by the first set of power characteristics. Additionally, as discussed previously, the first set of power characteristics (e.g., including first voltage level) may be constant or may vary during operation of the integrated circuit.

The exemplary method 600 may, at step 630, comprise (e.g., while generating the first signal) generating a second signal that is characterized by a second set of power characteristics. Step 630 may, for example and without limitation, perform a portion, all, or more than the functionality discussed previously with regard to the second modules 120, 220, 320, 435 and 535 of the exemplary systems illustrated in FIGS. 1-5 and discussed previously.

As discussed previously, such power characteristics may, for example and without limitation, comprise a second voltage level, second voltage tolerance level, second load response characteristic, second noise level, second current limit, and/or many other known power characteristics. Also, as discussed previously, the second signal corresponding to electrical power may comprise the electrical power or may comprise a control signal that causes power supply circuitry to generate the electrical power that is characterized by the second set of power characteristics. Additionally, as discussed previously, the second set of power characteristics (e.g., including second voltage level) may be constant or may vary during operation of the integrated circuit.

In an exemplary scenario, the second voltage level may be substantially similar to the first voltage level, and the second set of power characteristics may be substantially different than the first set of power characteristics. In another exemplary scenario, the second voltage level tolerance range may be substantially different than the first voltage tolerance range. In a further exemplary scenario, the second load response characteristics may be substantially different than the first load response characteristics. In yet another exemplary scenario, the second noise level may be substantially different than the first noise level. Accordingly, the scope of various aspects of the present invention should not be limited by one or more particular power characteristics.

In an exemplary scenario, the integrated circuit may comprise one or more modules that do not perform power supply functionality (e.g., signal processing circuitry). In such an exemplary scenario, the exemplary method 600 may comprise providing the electrical power that is characterized by the first set of power characteristics and/or the electrical power that is characterized by the second set of power characteristics to one or more of such modules.

In a further exemplary scenario, the integrated circuit may be a component of a larger electrical circuit that comprises any number of sub-circuits or modules. Such a larger circuit may, for example, be any of a large variety of electrical circuits. In the exemplary scenario, the method 600 may comprise providing the electrical power that is characterized by the first set of power characteristics and/or the electrical power that is characterized by the second set of power characteristics to one or more of such additional sub-circuits or modules.

The exemplary method 600 illustrated in FIG. 6 and discussed previously provides specific illustrative examples of a portion of various generally broader aspects of the present invention. Accordingly, the scope of various aspects of the present invention should not be limited by particular characteristics of the exemplary method 600.

FIG. 7 shows a flow diagram of a method 700 in an integrated circuit for providing multiple and controllable signals corresponding to electrical power (e.g., multiple controllable independent signals), in accordance with various aspects of the present invention. The method 700 may, for example and without limitation, share various aspects with the functionality performed by the exemplary integrated circuits illustrated in FIGS. 1-5 and discussed previously. Also for example and without limitation, the exemplary method 700 may share various characteristics with the exemplary method 600 illustrated in FIG. 6 and discussed previously.

As mentioned previously, the first, second and nth sets of power characteristics may be constant during operation of the integrated circuit or may vary. In the exemplary method 700, such power characteristics may vary.

The exemplary method 700 may begin at step 710. As with the exemplary method 600 illustrated in FIG. 6, the method 700 may begin in response to any of a large number of initiating causes or events. For example and without limitation, the method 700 may begin in response to a power-up event, a system reset event, a detected operating condition, a user command, predetermined periodic behavior, etc. Accordingly, the scope of various aspects of the present invention should not be limited by characteristics of any particular initiating cause or event.

The exemplary method 700 may, at step 720, comprise determining a first set of power characteristics (e.g., including the first voltage level). Step 720 may comprise determining the first set of power characteristics in any of a large variety of manners. For example, step 720 may comprise determining the power characteristics based at least in part on circuit performance goals and/or circuit energy efficiency goals. Step 720 may comprise determining the first set of power characteristics periodically or in response to real-time conditions. As mentioned previously, the first set of power characteristics may comprise any of a number of various known power characteristics. In general, step 720 may comprise determining at least a portion of the first set of power characteristics. Accordingly, the scope of various aspects of the present invention should not be limited by particular power characteristics, a manner of determining such power characteristics, or an initiating cause for making such a determination.

The exemplary method 700 may, at step 730, comprise outputting a first signal corresponding to electrical power characterized by the first set of power characteristics. As mentioned previously, such a first signal may comprise the electrical power or may comprise a control signal that causes the electrical power to be generated.

For example and without limitation, steps 720 and 730 may share various characteristics with the exemplary step 620 of the method 600 illustrated in FIG. 6 and discussed previously.

The exemplary method 700 may, at step 740, comprise determining a second set of power characteristics (e.g., including the second voltage level). Step 740 may comprise determining the second set of power characteristics in any of a large variety of manners. For example, step 740 may comprise determining the power characteristics based at least in part on circuit performance goals and/or circuit energy efficiency goals. Step 740 may comprise determining the second set of power characteristics periodically or in response to real-time conditions. As mentioned previously, the second set of power characteristics may comprise any of a number of various known power characteristics. In general, step 740 may comprise determining at least a portion of the second set of power characteristics. Accordingly, the scope of various aspects of the present invention should not be limited by particular power characteristics, a manner of determining such power characteristics, or an initiating cause for making such a determination. In a non-limiting exemplary scenario, step 740 may comprise determining different power characteristics than step 720 (e.g., in response to real-time events or conditions, changing performance needs, etc.).

The exemplary method 700 may, at step 750, comprise outputting a second signal corresponding to electrical power characterized by the second set of power characteristics. As mentioned previously, such a second signal may comprise the electrical power or may comprise a control signal that causes the electrical power to be generated.

For example and without limitation, steps 740 and 750 may share various characteristics with the exemplary step 630 of the method 600 illustrated in FIG. 6 and discussed previously.

The exemplary method 700 may, at step 795, comprise performing continued processing. Such continued processing may comprise characteristics of any of a large variety of continued processing activities. For example and without limitation, step 795 may comprise directing execution flow to a previous step (e.g., step 720). Step 795 may also, for example, comprise performing any of a variety of monitoring activities (e.g., to determine whether an adjustment in power supply characteristics is desirable). Step 795 may further, for example, comprise interacting with a user or other system components. Accordingly, the scope of various aspects of the present invention should not be limited by characteristics of any particular type of continued processing.

The exemplary method 700 illustrated in FIG. 7 and discussed previously provides specific illustrative examples of a portion of various generally broader aspects of the present invention. Accordingly, the scope of various aspects of the present invention should not be limited by particular characteristics of the exemplary method 700.

The systems and methods illustrated in FIGS. 1-7 are merely exemplary, and accordingly, the scope of various aspects of the present invention should not be limited by characteristics of the exemplary illustrations.

It should be stressed that various aspects of the present invention may be performed by hardware, a processor executing software instructions, or a combination thereof. Also, it should be noted that various modules and method steps may be implemented in hardware or software in varying degrees of integration. Accordingly, the scope of various aspects of the present invention should not be limited by characteristics of any particular implementation.

In summary, various aspects of the present invention provide a system and method for providing, in an integrated power supply circuit, multiple output signals corresponding to multiple respective electrical power signals.

While the invention has been described with reference to certain aspects and embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. An integrated circuit comprising:
a first module that outputs a first signal corresponding to electrical power that is characterized by a first set of power characteristics, where the first set of power characteristics comprises a first voltage level; and
a second module that outputs a second signal corresponding to electrical power that is characterized by a second set of power characteristics, where the second set of power characteristics comprises a second voltage level;
wherein the second voltage level is substantially similar to the first voltage level, and a portion of the first set of power characteristics is substantially different than a corresponding portion of the second set of power characteristics.

2. The integrated circuit of claim 1, wherein the first signal comprises the electrical power that is characterized by the first set of power characteristics, and the second signal comprises the electrical power that is characterized by the second set of power characteristics.

3. The integrated circuit of claim 1, wherein the first signal comprises a control signal that causes power supply circuitry to generate the electrical power that is characterized by the first set of power characteristics, and the second signal comprises a control signal that causes power supply circuitry to generate the electrical power that is characterized by the second set of power characteristics.

4. The integrated circuit of claim 1, wherein at least one of the first voltage level and the second voltage level is variable during operation of the integrated circuit.

5. The integrated circuit of claim 1, wherein at least one of the first set of power characteristics and the second set of power characteristics is variable during operation of the integrated circuit.

6. The integrated circuit of claim 1, wherein the first set of power characteristics comprises a first indication of voltage variability, and the second set of power characteristics comprises a second indication of voltage variability that is substantially different than the first indication of voltage variability.

7. The integrated circuit of claim 1, wherein the first set of power characteristics comprises a first load response, and the second set of power characteristics comprises a second load response that is substantially different than the first load response.

8. The integrated circuit of claim 1, further comprising a third module that outputs electrical power that is characterized by a third set of power characteristics, which includes a third voltage level that is substantially different than the first and second voltage levels.

9. The integrated circuit of claim 1, further comprising a third module that outputs electrical power that is characterized by a third set of power characteristics, which includes a third voltage level, wherein the third voltage level is substantially similar to the first and second voltage levels, and a portion of the third set of power characteristics is substantially different than corresponding respective portions of the first and second sets of power characteristics.

10. The integrated circuit of claim 1, further comprising a third module that does not perform power supply functionality, wherein the third module receives the electrical power that is characterized by the first set of power characteristics.

11. The integrated circuit of claim 1, further comprising a third module that does not perform power supply functionality, wherein the third module receives electrical power from the first module and the second module.

12. In an integrated circuit, a method for generating signals corresponding to electrical power, the method comprising:
generating a first signal corresponding to electrical power that is characterized by a first set of power characteristics, where the first set of power characteristics comprises a first voltage level; and
while generating the first signal, generating a second signal corresponding to electrical power that is characterized by a second set of power characteristics, where the second set of power characteristics comprises a second voltage level;
wherein the second voltage level is substantially similar to the first voltage level, and a portion of the first set of power characteristics is substantially different than a corresponding portion of the second set of power characteristics.

13. The method of claim 12, wherein the first signal comprises the electrical power that is characterized by the first set of power characteristics, and the second signal comprises the electrical power that is characterized by the second set of power characteristics.

14. The method of claim 12, wherein the first signal comprises a control signal that causes power supply circuitry to generate the electrical power that is characterized by the first set of power characteristics, and the second signal comprises a control signal that causes power supply circuitry to generate the electrical power that is characterized by the second set of power characteristics.

15. The method of claim 12, wherein at least one of the first voltage level and the second voltage level is variable during operation of the integrated circuit.

16. The method of claim 12, wherein at least one of the first set of power characteristics and the second set of power characteristics is variable during operation of the integrated circuit.

17. The method of claim 12, wherein the first set of power characteristics comprises a first indication of voltage variability, and the second set of power characteristics comprises a second indication of voltage variability that is substantially different than the first indication of voltage variability.

18. The method of claim 12, wherein the first set of power characteristics comprises a first load response, and the second set of power characteristics comprises a second load response that is substantially different than the first load response.

19. The method of claim 12, further comprising, while generating the first and second signals, generating a third signal corresponding to electrical power that is characterized by a third set of power characteristics, where the third set of power characteristics comprises a third voltage level that is substantially different than the first and second voltage levels.

20. The method of claim 12, further comprising, while generating the first and second signals, generating a third signal corresponding to electrical power that is characterized by a third set of power characteristics, where the third set of power characteristics comprises a third voltage level, and wherein the third voltage level is substantially similar to the first and second voltage levels, and a portion of the third set of power characteristics is substantially different than corresponding respective portions of the first and second sets of power characteristics.

21. The method of claim 12, further comprising providing the electrical power that is characterized by the first set of power characteristics to a first module of the integrated circuit, wherein the first module does not perform power supply functionality.

22. The method of claim 12, further comprising providing the electrical power that is characterized by the first set of power characteristics and the electrical power that is characterized by the second set of power characteristics to a first module of the integrated circuit, wherein the first module does not perform power supply functionality.

23. An electronic system comprising:
a signal processing circuit; and
a power supply circuit that provides electrical power to the signal processing circuit, wherein the power supply circuit comprises a power supply integrated circuit that comprises:
a first module that outputs a first signal corresponding to electrical power that is characterized by a first set of power characteristics, where the first set of power characteristics comprises a first voltage level; and
a second module that outputs a second signal corresponding to electrical power that is characterized by a second set of power characteristics, where the second set of power characteristics comprises a second voltage level;
wherein the second voltage level is substantially similar to the first voltage level and a portion of the first set of power characteristics is substantially different than a corresponding portion of the second set of power characteristics.

24. The electronic system of claim 23, wherein the first signal comprises the electrical power characterized by the first set of power characteristics, and the power supply circuit provides the first signal to the signal processing circuit.

25. The electronic system of claim 23, wherein the first signal comprises a control signal that causes the power supply circuit to provide the electrical power characterized by the first set of power characteristics to the signal processing circuit.

26. The electronic system of claim 23, wherein the power supply circuit further comprises power supply switching circuitry that receives the first signal from the first module and provides the electrical power characterized by the first set of power characteristics to the signal processing circuit.

27. The electronic system of claim 26, wherein the power supply switching circuitry further receives the second signal from the second module and provides the electrical power characterized by the second set of power characteristics to the signal processing circuit.
